(19) United States
(12) Patent Application Publication
(10) Pub. No.: US 2025/0268124 A1
(43) Pub. Date: Aug. 28, 2025

(54) AIR BOOM SPREADER FOR PARTICULATE MATERIAL AND AIR BOOM ASSEMBLY AND DROP TUBE THEREFOR

(71) Applicant: Salford Group Inc., Salford (CA)

(72) Inventors: Peter STOECKLI, Putnam (CA); John Mark AVERINK, Norwich (CA); Gavin HELD, Janesville, MN (US); Mark A. MAGEE, Urbandale, IA (US)

(73) Assignee: Salford Group Inc., Salford (CA)

(21) Appl. No.: 19/064,886

(22) Filed: Feb. 27, 2025

Related U.S. Application Data
(60) Provisional application No. 63/558,386, filed on Feb. 27, 2024.

(51) Int. Cl. A01C 15/00; A01C 15/04

(52) U.S. Cl. CPC A01C 15/003; A01C 15/007; A01C 15/04

(57) ABSTRACT

A drop tube for dropping particulate material from an air boom assembly has, in order: a rigid elbow connectable to an air boom outlet; an upper flexible section bendable in at least a direction parallel to a direction of travel of the air boom assembly; a rigid section having an air exhaust vent in a side thereof and a deflector therein; a lower flexible section bendable in at least the direction parallel to the direction of travel; and, an exit aperture having a cross-sectional area less than a cross-sectional area of the lower flexible section of the drop tube above the exit aperture.

### CROSS-REFERENCE TO RELATED APPLICATIONS

This application claims the benefit of U.S. Ser. No. 63/558,386 filed Feb. 27, 2024, the entire contents of which is herein incorporated by reference.

### FIELD

This application relates to agriculture, in particular to an apparatus for applying solid agricultural product to a field.

### BACKGROUND

Air boom spreading apparatuses for depositing particulate material (e.g., seed, fertilizer and the like) on the ground (e.g., in a field) in evenly spaced-apart rows are known, for example the apparatuses described in International Published Patent Applications WO 2018/170594 published Sep. 27, 2018 and WO 2021/06-2520 published Apr. 8, 2021. Such apparatuses generally comprise a hopper for containing the particulate material, a metering device that receives the particulate material from the hopper and partitions the particulate material into a plurality of outlets transversely spaced-apart on one or more booms in a direction perpendicular to the direction of travel of the apparatus, and, a plurality of air lines connecting the metering device to the plurality of outlets for conveying the particulate material in an air stream from the metering device to the plurality of outlets. A blower (e.g., a fan) provides the air stream and the apparatus may be self-propelled or towed by a prime mover (e.g., a truck, a tractor or the like).

Particulate material from the hopper is ultimately directed downwardly through the outlets on the boom toward the ground. To help control the flow of the particulate material out of the boom, the outlets may be fitted with drop tubes that extend downwardly from the boom outlets to bring the particulate material closer to the ground. However, especially for the application of fertilizer, the ends of the drop tubes remain above the ground instead of in a trench dug into the ground, which is commonly done for applying seed and liquid fertilizer. Because the ends of the drop tubes remain above the ground, particulate material (e.g., solid fertilizer) ejected from the drop tubes tends to bounce and scatter in random directions due to the speed of the apparatus, and hence the speed of the fertilizer, relative to the ground thereby creating a wider than desired spread pattern of the fertilizer on the ground.

There remains a need for a device that further helps control the flow of particulate material, especially fertilizer, out of a boom of an air boom spreader to provide suitably narrow strips of the particulate material on the ground as the air boom spreader travels along the ground.

### SUMMARY

A drop tube for dropping particulate fertilizer from an air boom assembly onto a field comprises: a rigid elbow connectable to an air boom outlet of the air boom assembly and configured to cooperate with the air boom outlet to direct the particulate fertilizer away from the air boom outlet into the drop tube and vertically downward in the drop tube when in operation; an upper flexible section connected to the rigid elbow and in particulate fertilizer communication with the rigid elbow to receive the particulate fertilizer from the rigid elbow, the upper flexible section bendable in at least a direction parallel to a direction of travel of the air boom assembly to permit flexing of the drop tube in response to contacting obstructions in the direction of travel; a rigid section connected to the upper flexible section and in particulate fertilizer communication with the upper flexible section to receive the particulate fertilizer from the upper flexible section, the rigid section comprising an air exhaust vent in a side thereof and a deflector therein, the deflector constricting flow of air and the particulate fertilizer in the rigid section to a position below the air vent where the deflector no longer restricts the flow of the air and particulate fertilizer; a lower flexible section connected to the rigid section and in particulate fertilizer communication with the rigid section to receive the particulate fertilizer from the rigid section; the lower flexible section bendable in at least the direction parallel to the direction of travel of the air boom assembly to permit flexing of the drop tube in response to contacting obstructions in the direction of travel; and, an exit aperture through which the particulate fertilizer exits the drop tube, the exit aperture having a cross-sectional area less than a cross-sectional area of the lower flexible section of the drop tube above the exit aperture.

An air boom assembly of an air boom spreader comprises a boom; a plurality of air boom outlets transversely spaced apart on the boom, a plurality of air lines terminating at respective air boom outlets of the plurality of air boom outlets; and, a plurality of drop tubes as described above connected to respective air boom outlets of the plurality of air boom outlets.

An air boom spreader for particulate fertilizer comprises: a hopper for containing the particulate fertilizer; a particulate fertilizer metering device in particulate fertilizer communication with the hopper, the metering device partitioning the particulate fertilizer into portions; a blower to generate an air stream; and, the air boom assembly described above, wherein the plurality of air lines are in fluid communication with the blower and in particulate fertilizer communication with the metering device to receive respective portions of the particulate fertilizer and transport the respective portions to the respective air boom outlets and then to respective drop tubes by the air stream.

The rigid elbow comprises a rigid pipe bent to redirect particulate material flowing substantially horizontally out of the air boom outlet toward the ground during operation of the air boom. The rigid elbow is configured to be joined to the air boom outlet so that the rigid elbow in particulate material communication with the air boom outlet. The rigid elbow is made of a non-bendable material, such as steel, hard plastic and the like. In some embodiments, the rigid elbow directs the particulate material vertically downward in the drop tube. In some embodiments, the rigid elbow comprises a first pipe portion and a second pipe portion whereby angle between longitudinal axes of the first and second pipe portions is sufficient to achieve the desired redirection of the particulate material. In some embodiments, the angle is in a range of 45-90°. In some embodiments, the angle is 90° and the rigid elbow is a 90-degree elbow. In some embodiments, the rigid elbow gradually bends (i.e., flow path of the particulate material gradually changes) while in other embodiments the rigid elbow abruptly bends (i.e., flow path of the particulate material sharply changes). In some embodiments, a proximal end of the rigid elbow is connectable to the air boom outlet by an insertion fit. In some embodiments, the proximal end of the first pipe portion has a small enough outside diameter to be insertable into the air boom outlet. In some embodiments, the proximal end of the first pipe portion has a large enough outside diameter to be able to have the air boom outlet at least partially inserted therein.

The upper flexible section is connected to and in particulate material communication with the rigid elbow. In some embodiments, a proximal end of the upper flexible section is connected to a distal end of the rigid elbow. The upper flexible section is in particulate material communication with the rigid elbow to receive the particulate material flowing downwardly from the rigid elbow. The upper flexible section is bendable in at least a direction parallel to a direction of travel of the air boom assembly to permit flexing of the drop tube in response to contacting obstructions in the direction of travel. In some embodiments, the direction parallel to the direction of travel is a rearward direction. In some embodiments, the upper flexible section is not bendable in a forward direction. In some embodiments, the upper flexible section is made of a bendable material, such as an elastomer (e.g., a rubber), a thermoplastic and the like. In some embodiments, the upper flexible section comprises an elastomeric hose, e.g., a rubber hose. In some embodiments, the upper flexible section is connected to the rigid elbow by a friction fit. In some embodiments, the connection is secured by at least one clamp (e.g., a hose clamp), an adhesive, a tape or any combination thereof.

The rigid section is connected to the upper flexible section and in particulate material communication with the upper flexible section. In some embodiments, a proximal end of the rigid section is connected to a distal end of the upper flexible section. The rigid section is in particulate material communication with the upper flexible section to receive the particulate material flowing downwardly from the upper flexible section. The rigid section is made of a non-bendable material, such as steel, hard plastic and the like. In some embodiments, the rigid section comprises a rigid pipe. In some embodiments, the rigid section is connected to the upper flexible section by a friction fit. In some embodiments, the connection is secured by at least one clamp (e.g., a hose clamp), an adhesive, a tape or any combination thereof.

The rigid section comprises an air exhaust vent in a side thereof, for example a rear side thereof, and a deflector therein. In some embodiments, the air vent comprises a notch cut into the side of the rigid section, the notch having a substantially horizontal lower edge extending arcuately along a circumferential wall of the rigid section so that ends of the lower edge are opposed through an interior of the rigid section along a chord through the interior of the rigid section. The notch further has an upper edge extending between the ends of the lower edge forming a parabola with an apex above the lower edge. The parabola angled from the apex of the parabola to the ends of the lower edge with respect to vertical and horizontal.

The deflector acts, at least in part, to deflect particulate material away from the air vent so that no particulate material can escape the drop tube before reaching the exit aperture. In some embodiments, the deflector comprises a plate installed in the interior of the rigid section extending between the upper edge of the notch and the ends of the lower edge of the notch. As such, the plate extends from the upper edge of the notch at an angle downwardly into the interior of the rigid section thereby gradually reducing the effective cross-sectional area of the rigid section through which the particulate material flows. Side edges of the plate are shaped to conform to the upper edge of the notch to seal the upper edge of the notch to the air flow and the flow of particulate as the air flow and the particulate material are deflected by contact with the plate. The plate extends beyond the upper edge of the notch to an exterior of the rigid section and extends beyond the lower edge of the notch in the interior of the rigid section. In this way, the plate is held in place by the upper and lower edges of the notch together with a clamp. In some embodiments, a lower portion of the plate is angled more downwardly with respect to an upper portion of the plate. The upper portion of the plate deflects the air and particulate material flowing downwardly from above the notch and the plate gradually reduces the effective cross-sectional area of the rigid section through which the particulate material flows in the region of the notch. The lower portion of the plate either reduces or halts the rate of reduction of the effective cross-sectional area of the rigid section through which the particulate material flows. In some embodiments, the lower portion of the plate begins proximate the lower edge of the notch, for example just above the lower edge of the notch. In some embodiments, the lower portion of the plate extends parallel to the walls of the rigid section to a position below the lower edge of the notch thereby separating the interior of the rigid section into two longitudinal channels, a first channel through which the particulate material flows downwardly and a second channel in fluid communication the notch through which air in the drop tube can be vented. At a lower end of the lower portion of the plate, the effective cross-sectional area of the rigid section through which the particulate material flows abruptly increases to the cross-sectional area of the rigid section and the particulate material continues to flow downwardly past the plate while a portion of air flow is redirected upward through the air vent.

The deflector is in the interior of the rigid section and constricts flow of air and the particulate material in the rigid section from a position above the air vent to a position below the air vent where the deflector no longer restricts the flow of the air and particulate material. In effect, the deflector reduces an effective cross-sectional area of the interior of the rigid section in a region of the air event and guides both the downward air flow and the downward flow of particulate material into a smaller volume as the air and particulate material flow past the position of the air event while isolating the air flow and the particulate material flow from the air event in this region of the rigid section. The deflector extends sufficiently far below the air vent that once the particulate material flow is past the deflector where the effective cross-sectional area of the interior of the rigid section once again expands to be defined only by walls of the rigid section, the particulate material continues to flow down under the influence of gravity without being ejected through the air vent.

The lower flexible section is connected to and in particulate material communication with the rigid section. In some embodiments, a proximal end of the lower flexible section is connected to a distal end of the rigid section. The lower flexible section is in particulate material communication with the rigid section to receive the particulate material flowing downwardly from the rigid section. The lower flexible section is bendable in at least the direction parallel to the direction of travel of the air boom assembly to permit flexing of the drop tube in response to contacting obstructions in the direction of travel. In some embodiments, the direction parallel to the direction of travel is the rearward direction. In some embodiments, the lower flexible section is made of a bendable material, such as an elastomer (e.g., a rubber), a thermoplastic and the like. In some embodiments, the lower flexible section comprises an elastomeric hose, e.g., a rubber hose. In some embodiments, the lower flexible section is connected to the rigid section by a friction fit. In some embodiments, the connection is secured by a clamp (e.g., a hose clamp), an adhesive, a tape or any combination thereof.

The exit aperture is an opening at a distal end of the drop tube through which the particulate material exits the drop tube. The exit aperture is a constricted opening having a cross-sectional area less than a cross-sectional area of the lower flexible section of the drop tube above the exit aperture. Because the exit aperture has a smaller cross-sectional area than the cross-sectional area of most of the drop tube, a restriction in the air flow is caused at the exit aperture, which slows the rate of fall of the particulate material but risks plugging the drop tube. However, the restriction in the air flow caused by the exit aperture is relieved by some of the air flowing upwardly and out through the air vent thereby avoiding plugging of the drop tube with the particulate material. In some embodiments, the exit aperture is an opening at a bottom end (distal end) of the lower flexible section. In some embodiments, the drop tube further comprises a rigid outlet tube connected to and in particulate material communication with the lower flexible section to receive the particulate material from the lower flexible section. The rigid outlet tube therefore comprises the exit aperture. In some embodiments, the rigid outlet tube is connected to the lower flexible section by a friction fit. In some embodiments, the connection is secured by at least one clamp (e.g., a hose clamp), an adhesive, a tape or any combination thereof.

In some embodiments, the drop tube further comprises a guide for reducing transverse flexing of the drop tube relative to the direction parallel to the direction of travel while permitting longitudinal flexing of the guide tube in the direction parallel to the direction of travel. In some embodiments, the guide permits longitudinal flexing of the guide tube in a rearward direction while constraining flexing of the drop tube in the transverse direction and in a forward direction. In some embodiments, the guide comprises a ring around but not attached to a circumference of the rigid section of the drop tube whereby the rigid section can move horizontally within the ring. In some embodiments, the guide comprises a hinge rigidly connected to the elbow. In some embodiments, the hinge comprises a hinge pin. In some embodiment, the hinge pin is oriented horizontally with respect to the ground during operation. In some embodiments, the guide comprises a rod connected to the ring, preferably rigidly connected to the ring, and pivotally connected to the hinge. In some embodiments, the rod is pivotable on the hinge in the direction parallel to the direction of travel but not pivotable in a direction transverse to the direction of travel. In some embodiments, the rod is pivotable on the hinge in a rearward direction but not a forward direction relative to the direction of travel. In some embodiments, the ring is above the air exhaust vent and the deflector (i.e., the air exhaust vent and the deflector are below the ring).

Because the flow of particulate material has been slowed in the drop tube by the deflector and by the exit aperture having a smaller cross-sectional area, particulate material will exit the drop tube at a lower velocity thereby reducing the tendency of the particulate material to bounce and scatter when dropped on the field, especially when the particulate material is not being deposited in a furrow. By controlling the size of the air vent, the location of the air vent, the length of the deflector, the total length of the drop tube and the cross-sectional area of the exit aperture, it is possible to adjust the exit velocity of the particulate material to a desired velocity, for example to near a zero velocity.

The combination of flexible sections and a rigid section, especially with the rigid section between the flexible sections, helps the drop tube travel through crops (e.g., corn and other tall crop plants) without being pushed out of alignment with a crop row by the crop plants while providing some flexibility in the direction of travel so that when the drop tube encounters an obstruction (e.g., plant leaves, plant stalks and the like) in the direction of travel of the air boom spreader, damage to one or both of the drop tube and the crop is minimized.

The drop tube comprising a combination of the air vent, the deflector, the flexible and rigid sections, and the constricted exit opening, especially further in combination with the guide, provide much narrow strips of the particulate material on the ground between crop rows as the air boom spreader travels in a field during an agricultural operation.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a rear view of an embodiment of a drop tube for particulate fertilizer being spread from an air boom spreader.

FIG. 2A depicts an exploded isometric view of the drop tube of FIG. 1.

FIG. 2B depicts an exploded side view of the drop tube of FIG. 1.

FIG. 2C depicts an exploded rear view of the drop tube of FIG. 1.

FIG. 3 depicts a magnified side cross-sectional view of a rigid section of the drop tube of FIG. 1 illustrating an air exhaust aperture and a deflector in the drop tube.

FIG. 4 depicts an air boom assembly of an air boom spreader having a plurality of the drop tubes of FIG. 1 fitted to a corresponding plurality of air boom outlets on a boom of the air boom assembly.

FIG. 5 depicts an air boom spreader having the air boom assembly of FIG. 4 mounted thereon.

### DETAILED DESCRIPTION

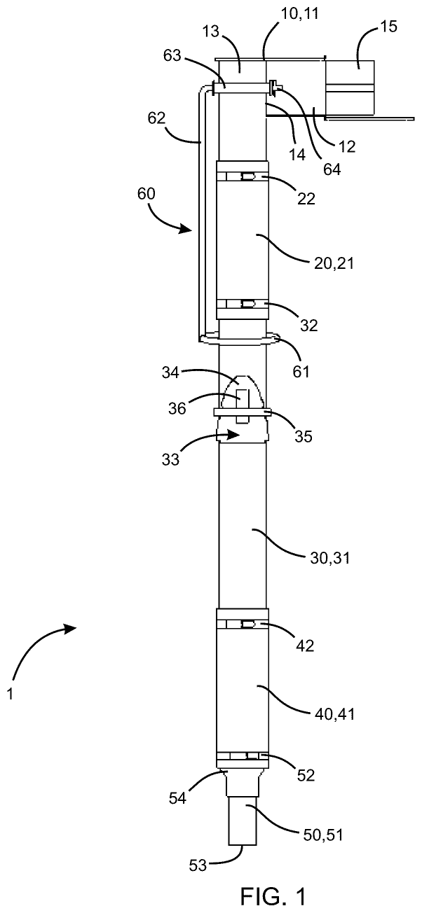

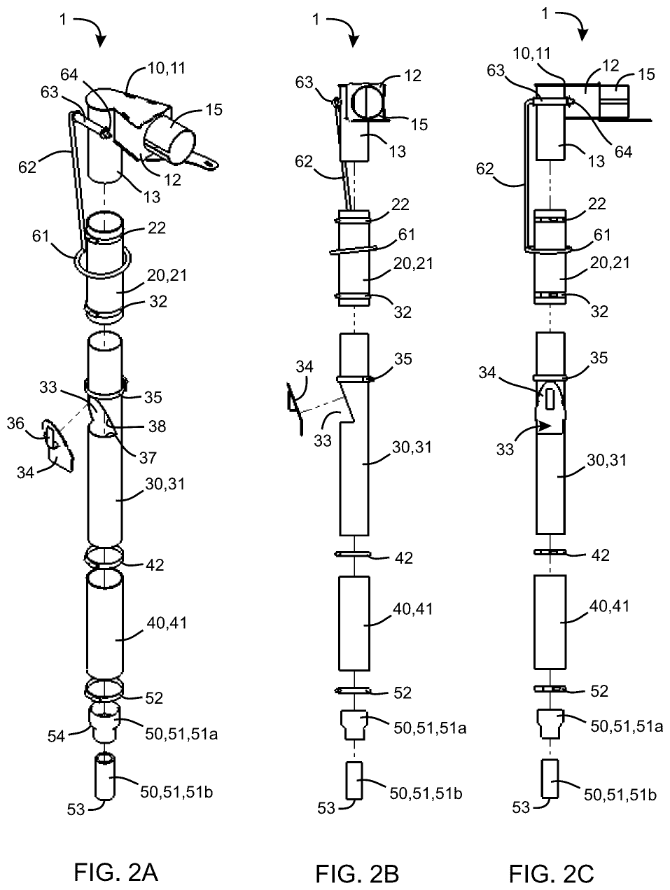

With reference to FIG. 1 to FIG. 3, a drop tube 1 for particulate fertilizer spread by an air boom spreader. comprises five tube sections including a rigid elbow 10, an upper flexible section 20, a rigid section 30, a lower flexible section 40 and a drop tube outlet 50.

The rigid elbow 10 comprises a steel pipe 11 having a horizontally oriented first pipe portion 12 and a vertically oriented second pipe portion 13 that meet at a 90° joint 14. A proximal end of the first pipe portion 11 comprises a friction fitting 15 for connecting the drop tube 1 to an air boom outlet on an air boom assembly. Alternatively, or additionally, the proximal end of the first pipe portion can be connected to the air boom outlet by at least one clamp, for example two clamps. Particulate fertilizer flowing from the air boom outlet into the elbow 10 is directed downwardly into the second pipe portion 13.

The upper flexible portion 20 comprises a rubber hose 21 connected to a distal end of the second pipe portion 13 of the elbow 10 by insertion of the distal end of the second pipe portion 13 into a proximal end of the upper flexible portion 20 so that the rubber hose 21 conforms to and frictionally grips the second pipe portion 13. The connection is secured using a first hose clamp 22. The upper flexible portion 20 is oriented vertically so that particulate fertilizer flows vertically downward from the elbow 10 into the upper flexible portion 20 where the particulate fertilizer continues to flow vertically downward.

The rigid section 30 comprises a steel pipe 31 connected to a distal end of the upper flexible portion 20 by insertion of a proximal end of the steel pipe 31 into the distal end of the upper flexible portion 20 so that the rubber hose 21 conforms to and frictionally grips the proximal end of the steel pipe 31. The connection is secured using a second hose clamp 32. The rigid section 30 is oriented vertically so that particulate fertilizer flows vertically downward from the upper flexible portion 20 into the rigid section 30 where the particulate fertilizer continues to flow vertically downward. The rigid section 30 further comprises an air exhaust vent 33, which is an aperture in a rearward side of the steel pipe 31 located near the proximal end of the steel pipe 31. Associated with the air exhaust vent 33 is a deflector 34 comprising a steel deflection plate situated inside the steel pipe 31.

The lower flexible portion 40 comprises a rubber hose 41 connected to a distal end of the steel pipe 31 by insertion of a distal end of the steel pipe 31 into a proximal end of the lower flexible portion 40 so that the rubber hose 41 conforms to and frictionally grips the distal end of the steel pipe 31. The connection is secured using a third hose clamp 42. The lower flexible portion 40 is oriented vertically so that particulate fertilizer flows vertically downward from the rigid section 30 into the lower flexible portion 40 where the particulate fertilizer continues to flow vertically downward.

The drop tube outlet 50 comprises a steel tube 51 connected to a distal end of the rubber hose 41 by insertion of a proximal end of the steel tube 51 into the distal end of the lower flexible portion 40 so that the rubber hose 41 conforms to and frictionally grips the proximal end of the steel tube 51. The connection is secured using a fourth hose clamp 52. The drop tube outlet 50 is oriented vertically so that particulate fertilizer flows vertically downward from the lower flexible portion 40 into the drop tube outlet 50 where the particulate fertilizer continues to flow vertically downward until the particulate fertilizer exits the drop tube 1 at an exit aperture 53 at a distal end of the steel tube 51. The steel tube 51 has an inward taper 54 at least partially along a length of the drop tube outlet 50, which narrows the drop tube outlet 50. The steel tube 51 can be a single tube or provided in two or more parts. As seen in the Figures, the steel tube 51 is provided as an upper tapered part 51a and a lower straight part 51b, which are fitted together by a friction fit. As a result of the taper 54, the exit aperture 53 has a smaller cross-sectional area than the elbow 10, the upper flexible section 20, the rigid section 30 and the lower flexible section 40, which causes the particulate fertilizer flowing through the drop tube 1 to slow thereby slowing the rate of fall of the particulate fertilizer exiting the drop tube 1.

The drop tube 1 further comprises a guide 60 for constraining transverse and forward flexing of the drop tube 1. The guide 60 comprises a guide ring 61, a guide rod 62 and a guide hinge 63. The guide hinge 63 is fixedly attached to a rear side the second pipe portion 13 of the elbow 10, so that a rotatable hinge pin 64 of the guide hinge 63 is oriented horizontally. A proximal end of the guide rod 62 is fixedly attached to the hinge pin 64 so that the guide rod is pivotally connected to the guide hinge 63. The hinge pin 64 may be monolithic with the guide rod 62, in which case the hinge pin 64 can be an extension of the guide rod 62 as illustrated in the Figures. Alternatively, the guide rod 62 may be welded, glued, bolted or the like to the hinge pin 64. The guide rod 62 extends downwardly from the guide hinge 63 and a distal end of the guide rod 62 is fixedly attached to the guide ring 61. The guide ring 61 encircles the rigid section 30 at a location above the air exhaust vent 33 and below the distal end of the upper flexible portion 20. A gap between the guide ring 61 and the rigid section 30 permits some movement of the rigid section 30 within the guide ring 61. However, because the hinge pin 64 is located on the rear side of the elbow 10 and is horizontally oriented, transverse and forward motions of the rigid section 30 are constrained only to the size of the gap between the rigid section 30 and the guide ring 61. On the other hand, when the rigid section 30 moves rearward to encounter the guide ring 61, further rearward motion of the rigid section 30 causes the guide rod 62 to pivot on the guide hinge 63 about a rotation axis of the hinge pin 64 allowing for considerable rearward flexing of the drop tube 1.

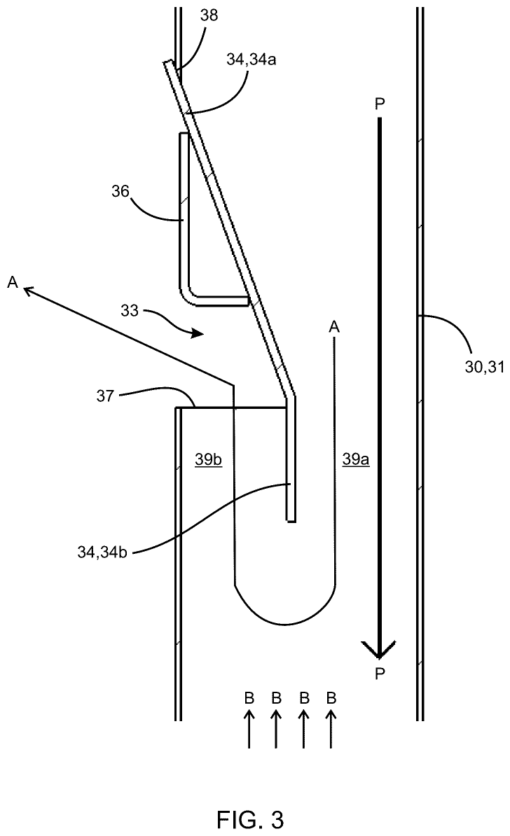

With specific reference to FIG. 3, the rigid section 30 of the drop tube 1 comprises the air exhaust vent 33 in the rearward side of the steel pipe 31. The air exhaust vent 33 comprises a lower edge 37 and an upper edge 38. The lower edge 37 is formed by a horizontal arcuate section of a wall of the steel pipe 31 and the upper edge 38 is formed by a parabolic section of the wall of the steel pipe 31, the parabolic section having an apex above the lower edge 37 and arms extending downwardly to meet the lower edge 37 at ends of the lower edge 37 thereby forming a notch in the rearward side of the steel pipe 31. The deflector 34 comprises an upper plate portion 34a, a lower plate portion 34b and a handle 36 attached to an outer face of the upper plate portion 34a. The handle 36 is used to grip the deflector 34 for insertion and removal of the deflector 34 into and out of the drop tube 1 through the air exhaust vent 33. Once inserted into the drop tube 1, the deflector 34 is secured in place by a deflection plate clamp 35. Inside the drop tube 1, an inner face of the upper plate portion 34a of the deflector 34 engages the upper edge 38 of the air exhaust vent 33 and the upper plate portion 34a extends inwardly into the steel pipe 31 at a non-vertical downwardly oriented angle, for example at an angle in a range of about 10-45° relative to a longitudinal axis of the drop tube 1. The lower plate portion 34b forms an angle with the upper plate portion 34a such that the lower plate portion 34b extends vertically downward inside the steel pipe 31 from a distal end of the upper plate portion 34a. The lower plate portion 34b meets the upper plate portion 34a at a position just above the lower edge 37 of the air exhaust vent 33 so that an outer face of the lower plate portion 34b engages the lower edge of the air exhaust vent 33. Together the deflection plate clamp 35, engagement of inner face of the upper plate portion 34a with the upper edge 38 of the air exhaust vent 33 and engagement of the outer face of the lower plate portion 34b with the lower edge of the air exhaust vent 33 both holds the deflector 34 in place and seals the air exhaust vent 33 along the upper edge 38 so that air and particulate fertilizer cannot escape the drop tube 1 through the air exhaust vent 33 along the upper edge 38. The lower plate portion 34b extends downwardly in the steel pipe 31 for a distance far enough below the lower edge 37 of the air exhaust vent 33 so that particulate fertilizer cannot escape the drop tube 1 through the air exhaust vent 33 along the lower edge 37 of the air exhaust vent 33.

As further seen in FIG. 3, below the air exhaust vent 33, the lower plate portion 34b divides the steel pipe 31 into two parallel channels, a first channel 39a and a second channel 39b. As particulate material and air flow downwardly in the rigid portion 30 along a particulate material flow path P and an air flow path A, respectively, the upper plate portion 34a of the deflector 34 deflects the particulate material and air away from the air exhaust vent 33 into a progressively smaller volume thereby restricting the air flow as the particulate material and the air flow past the deflector 34 until the particulate material flow path P and the air flow path A enter the first channel 39b where the air flow restriction stops. When the particulate material and air flow past a distal end of the lower plate portion 34b, the volume abruptly increases. However, as described above, the exit aperture 53 at the distal end of the drop tube 1 has a smaller cross-sectional area than the tube sections 10, 20, 30 and 40, which provides a reverse air flow B on the particulate fertilizer flowing through the drop tube 1. The reverse air flow B is experienced at the distal end of the lower plate portion 34b. The particulate fertilizer has sufficient mass to continue flowing downwardly, albeit slowly, along the particulate material flow path P, but at least a portion of the air flow A is redirected upwardly to flow through the second channel 39b to be vented out the air exhaust vent 33 to prevent clogging of the exit aperture 53 by the particulate material.

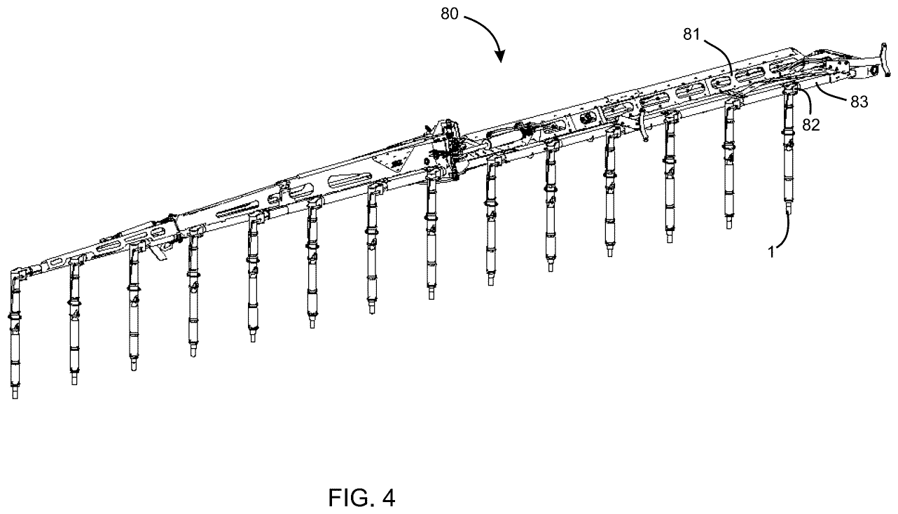

FIG. 4 illustrates an air boom assembly 80 comprising a boom 81 having a plurality of air boom outlets 82 (only one labeled) to which the particulate fertilizer is carried by a plurality of corresponding air lines 83 (only one labeled), the plurality of air boom outlets 81 fitted with corresponding drop tubes 1 (only one labeled).

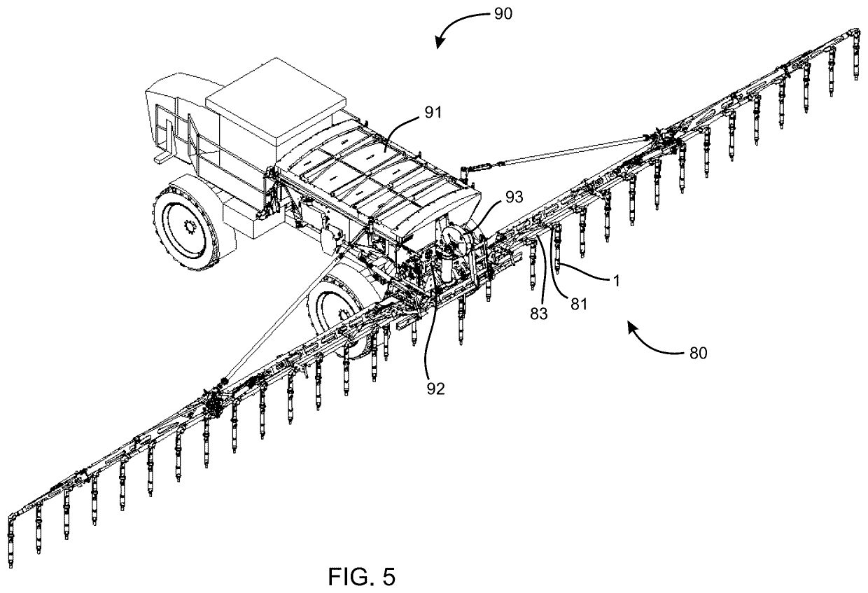

FIG. 5 illustrates an air boom spreader 90 having mounted thereon the air boom assembly 80. The air boom spreader 90 comprises a hopper 91 for containing particulate fertilizer, a metering device 92 in particulate fertilizer communication with the hopper, the metering device partitioning the particulate fertilizer into portions, a blower 93 to generate an air stream. Particulate fertilizer is fed from the hopper 91 to the metering device 92 where the particulate fertilizer is apportioned to individual air lines 83 (only one labeled). The blower 93 generates an air stream that carries the particulate fertilizer through the air lines 83 to the air boom outlets 81 (only one labeled). From the air boom outlets 81, the particulate material is delivered on to a field through the drop tubes 1 (only one labeled).

The novel features will become apparent to those of skill in the art upon examination of the description. It should be understood, however, that the scope of the claims should not be limited by the embodiments but should be given the broadest interpretation consistent with the wording of the claims and the specification as a whole.

1. A drop tube for dropping particulate fertilizer from an air boom assembly onto a field, the drop tube comprising:
a rigid elbow connectable to an air boom outlet of the air boom assembly and configured to cooperate with the air boom outlet to direct the particulate fertilizer away from the air boom outlet into the drop tube and vertically downward in the drop tube when in operation;
an upper flexible section connected to the rigid elbow and in particulate fertilizer communication with the rigid elbow to receive the particulate fertilizer from the rigid elbow, the upper flexible section bendable in at least a direction parallel to a direction of travel of the air boom assembly to permit flexing of the drop tube in response to contacting obstructions in the direction of travel;
a rigid section connected to the upper flexible section and in particulate fertilizer communication with the upper flexible section to receive the particulate fertilizer from the upper flexible section, the rigid section comprising an air exhaust vent in a side thereof and a deflector therein, the deflector constricting flow of air and the particulate fertilizer in the rigid section to a position below the air vent where the deflector no longer restricts the flow of the air and particulate fertilizer;
a lower flexible section connected to the rigid section and in particulate fertilizer communication with the rigid section to receive the particulate fertilizer from the rigid section; the lower flexible section bendable in at least the direction parallel to the direction of travel of the air boom assembly to permit flexing of the drop tube in response to contacting obstructions in the direction of travel; and,
an exit aperture through which the particulate fertilizer exits the drop tube, the exit aperture having a cross-sectional area less than a cross-sectional area of the lower flexible section of the drop tube above the exit aperture.

2. The drop tube of claim 1, wherein the exit aperture is an opening at a bottom end of the lower flexible section.

3. The drop tube of claim 1, further comprising a rigid outlet tube connected to and in particulate fertilizer communication with the lower flexible section to receive the particulate material from the lower flexible section, wherein the rigid outlet tube comprises the exit aperture.

4. The drop tube of claim 1, further comprising a guide for reducing transverse flexing of the drop tube relative to the direction parallel to the direction of travel while permitting longitudinal flexing of the guide tube in the direction parallel to the direction of travel.

5. The drop tube of claim 4, wherein the guide comprises a ring around but not attached to a circumference of the rigid section of the drop tube whereby the rigid section can move horizontally within the ring, a hinge rigidly connected to the elbow, and a rod connected to the ring and pivotally connected to the hinge, whereby the rod is pivotable on the hinge in the direction parallel to the direction of travel but not pivotable in a direction transverse to the direction of travel.

6. The drop tube of claim 5, wherein the air exhaust vent and the deflector are below the ring.

7. The drop tube of claim 1, wherein the flexible sections comprise elastomeric hoses.

8. The drop tube of claim 1, wherein the rigid section comprises a rigid pipe.

9. The drop tube of claim 1, wherein the connections are secured with clamps.

10. The drop tube of claim 1, wherein the rigid elbow is a 90-degree elbow.

11. An air boom assembly of an air boom spreader, the air boom assembly comprising:
a boom;
a plurality of air boom outlets transversely spaced apart on the boom,
a plurality of air lines terminating at respective air boom outlets of the plurality of air boom outlets; and,
a plurality of drop tubes as defined in claim 1 connected to respective air boom outlets of the plurality of air boom outlets.

12. An air boom spreader for particulate fertilizer, the air boom spreader comprising:
a hopper for containing the particulate fertilizer;
a particulate fertilizer metering device in particulate fertilizer communication with the hopper, the metering device partitioning the particulate fertilizer into portions;
a blower to generate an air stream; and,
the air boom assembly as defined in claim 11,
wherein the plurality of air lines are in fluid communication with the blower and in particulate fertilizer communication with the metering device to receive respective portions of the particulate fertilizer and transport the respective portions to the respective air boom outlets and then to respective drop tubes by the air stream.
